(19) United States
(12) Patent Application Publication
(10) Pub. No.: US 2019/0352227 A1
(43) Pub. Date: Nov. 21, 2019

(54) CHEMICALLY STRENGTHENED GLASS

(71) Applicant: AGC Inc., Chiyoda-ku (JP)

(72) Inventors: Akio Koike, Tokyo (JP); Yusuke Kobayashi, Tokyo (JP)

(73) Assignee: AGC Inc., Chiyoda-ku (JP)

(21) Appl. No.: 16/531,550

(22) Filed: Aug. 5, 2019

Related U.S. Application Data
(63) Continuation of application No. PCT/JP2018/004079, filed on Feb. 6, 2018.

(30) Foreign Application Priority Data
Feb. 7, 2017 (JP) 2017-020793

(51) Int. Cl. C03C 21/00; C03C 3/085

(52) U.S. Cl. CPC C03C 21/002; C03C 2204/00; C03C 3/085

(57) ABSTRACT

A chemically strengthened glass includes a compressive stress layer. A compressive stress is 200 MPa or more at a surface of the chemically strengthened glass. A depth in the compressive stress layer at which the compressive stress is 50 MPa from the surface is 50 μm or more. A depth in the compressive stress layer at which the compressive stress is 30 MPa from the surface is 60 μm or more. A critical stress intensity factor K_{IC} is 0.75 MPa·m^{1/2} or more.

### CROSS-REFERENCE TO RELATED APPLICATION

The present application is a continuation application filed under 35 U.S.C. 111(a) claiming benefit under 35 U.S.C. 120 and 365(c) of PCT International Application No. PCT/JP2018/004079 filed on Feb. 6, 2018 and designating the U.S., which claims priority of Japanese Patent Application No. 2017-020793 filed on Feb. 7, 2017. The entire contents of the foregoing applications are incorporated herein by reference.

### BACKGROUND OF THE INVENTION

### 1. Field of the Invention

The present invention relates to a chemically strengthened glass.

### 2. Description of the Related Art

Display units and casings of electronic devices, such as mobile phones or smartphones often include chemically strengthened glasses in which surface layers are formed by ion exchange processes. Thicknesses of the chemically strengthened glass tend to become thinner according to the requirement for reducing weights (referred to as “thinning”). In order to increase strengths of thinned glasses, surface compressive stresses (CS) tend to become higher, and depths of compressive stress layers (DOL) tend to increase.

In particular, the DOL of mobile electronic devices tend to increase so that chemically strengthened glasses do not easily break when the electronic devices fall (See U.S. Patent Application Publication No. 2015/0239775).

### SUMMARY OF THE INVENTION

### Problem to be Solved by the Invention

However, the chemically strengthened glass disclosed in U.S. Patent Application Publication No. 2015/0239775 has a problem that when an electronic device falls on an asphalt surface, the chemically strengthened glass breaks easily despite the great depth of the compressive stress layer (DOL).

The present invention has been made in view of the above-described problem, and aims to provide a chemically strengthened glass that is less likely to break than conventional chemically strengthened glasses when the glass falls on an asphalt surface, by controlling a balance between the surface compressive stress (CS) and the depth of the compressive stress layer (DOL).

### Means for Solving Problems

In order to solve the problem, according to an aspect of the present invention, a chemically strengthened glass including a compressive stress layer,

a compressive stress being 200 MPa or more at a surface of the chemically strengthened glass,

a depth in the compressive stress layer at which the compressive stress is 50 MPa from the surface being 50 μm or more,

a depth in the compressive stress layer at which the compressive stress is 30 MPa from the surface being 60 μm or more, and

a critical stress intensity factor K_{IC} being 0.75 MPa·m^{1/2} or more.

### Effect of Invention

According to the present invention, a chemically strengthened glass that is less likely to break when the glass falls on an asphalt surface is provided.

### BRIEF DESCRIPTION OF THE DRAWINGS

Other objects and further features of embodiments will become apparent from the following detailed description when read in conjunction with the accompanying drawings, in which:

FIG. 1 is a diagram depicting an example of a relation between a depth at which a compressive stress is 50 MPa from a glass surface and a height of drop when a dropped glass breaks, for chemically strengthened glasses according to Examples 1 to 3; and

FIG. 2 is a diagram depicting an example of a relation between a depth at which a compressive stress is 30 MPa from a glass surface and a height of drop when a dropped glass breaks, for chemically strengthened glasses according to Examples 1 to 3.

### DETAILED DESCRIPTION OF THE PREFERRED EMBODIMENTS

### Embodiment

(Chemically Strengthened Glass)

A chemically strengthened glass according to an embodiment has a plate shape. The present invention is not limited to this, and the chemically strengthened glass may be a flat plate or may be a glass plate subjected to a bending treatment. The chemically strengthened glass according to the embodiment is a glass plate formed into a shape of a flat plate by using a known method, such as a float method, a fusion method, or a slot down-draw method. The chemically strengthened glass preferably has a liquidus viscosity of 130 dPa·s or more.

The chemically strengthened glass according to the embodiment is applied to a cover glass and a touch sensor glass in a touch panel display provided in an information processing device such as a tablet type PC, a laptop computer, a smartphone or an electronic book reader; a cover glass in a liquid crystal display television, a display device of a personal computer or the like; a cover glass in an instrument panel module for vehicle or the like; a cover glass in a photovoltaic cell; an interior construction material; a multilayered glass for a window in a building or a house; and the like.

The chemically strengthened glass according to the embodiment has dimensions that are allowed in an existing forming method. For example, the chemically strengthened glass obtained by using a float method has a shape of a continuous ribbon with a width formed in the float method. The chemically strengthened glass according to the embodiment is finally cut into pieces with a size for use.

Specifically, the chemically strengthened glass having a size according to the purpose of use, such as a display device of a tablet type PC or a smartphone, or a cover glass of a photovoltaic cell, is prepared. The chemically strengthened glass according to the embodiment is cut into pieces having a rectangular shape. The shape of the piece is not limited to a rectangle, and the shape may be a circle, a polygon, or the like. The piece may be subjected to a drilling process.

A plate thickness t of the chemically strengthened glass according to the embodiment is preferably 2000 μm or less in order to reduce the weight of the device. The plate thickness t is more preferably 1500 μm or less, 1000 μm or less, 800 μm or less, 700 μm or less, 500 μm or less, 400 μm or less, 300 μm or less, 200 μm or less, or 100 μm or less.

The chemically strengthened glass according to the embodiment is provided with a compressive stress layer on a glass surface, which is formed by an ion exchange process. A surface compressive stress (CS) of the chemically strengthened glass is preferably 200 MPa or more, and is more preferably 300 MPa or more, 500 MPa or more, 600 MPa or more, 650 MPa or more, 700 MPa or more, 750 MPa or more, 800 MPa or more, 900 MPa or more, or 1000 MPa or more.

A compressive stress value tends to decrease in accordance with depth from the surface. When a depth of crack occurring in use of a chemically strengthened glass exceeds a depth of a compressive stress layer (DOL), the glass may break. Thus, the depth of the compressive stress layer (DOL) in the chemically strengthened glass according to the embodiment is preferably great. The depth of the compressive stress layer (DOL) is preferably 30 μm or more, and is more preferably 40 μm or more, 50 μm or more, 55 μm or more, 60 μm or more, 65 μm or more, 70 μm or more, 75 μm or more, 80 μm or more, 85 μm or more, 90 μm or more, 95 μm or more, 100 μm or more, 110 μm or more, 120 μm or more, 130 μm or more, 140 μm or more, or 150 μm or more.

Moreover, the depth of the compressive stress layer (DOL) is preferably 0.10t or more, where t is the plate thickness. The DOL is more preferably 0.12t or more, further preferably 0.15t or more, and especially 0.20t or more.

A depth at which the compressive stress is 50 MPa from a glass surface in the compressive stress layer is preferably 50 μm or more. The inventors of the present application have found that as the depth at which the compressive stress is 50 MPa increases, the glass is less likely to break when a sharp object collides with the glass surface (such as from dropping) to generate a crack. Thus, the depth at which the compressive stress is 50 MPa from the glass surface in the compressive stress layer is more preferably 55 μm or more, 60 μm or more, 65 μm or more, 70 μm or more, 75 μm or more, 80 μm or more, 85 μm or more, 90 μm or more, 95 μm or more, 100 μm or more, 110 μm or more, 120 μm or more, 130 μm or more, 140 μm or more, or 150 μm or more. The above-described relations between the DOL and the plate thickness t are also applied to this case.

A depth at which the compressive stress is 30 MPa from the glass surface in the compressive stress layer is preferably 60 μm or more. The inventors of the present application have found that as the depth at which the compressive stress is 30 MPa increases, the glass is less likely to break when a crack occurs (such as from dropping) and a bending force is applied to the glass. Thus, the depth at which the compressive stress is 30 MPa from the glass surface in the compressive stress layer is more preferably 65 μm or more, 70 μm or more, 75 μm or more, 80 μm or more, 85 μm or more, 90 μm or more, 95 μm or more, 100 μm or more, 105 μm or more, 110 μm or more, 115 μm or more, 120 μm or more, 125 μm or more, 130 μm or more, 135 μm or more, 140 μm or more, or 150 μm or more. The above-described relations between the DOL and the plate thickness t are also applied to this case.

A critical stress intensity factor K_{IC} of the chemically strengthened glass according to the embodiment is preferably 0.75 MPa·m^{1/2} or more. The critical stress intensity factor K_{IC} in the present application refers to a value of a stress intensity factor (K_{I}) when a crack velocity (V) is 0.1 m/sec in a K_{I}-V curve obtained by using a double cleavage drilled compression (DCDC) method or the like. In order not only to increase a strength of the glass but also to reduce frangibility, which will be described later, so that fragments are less likely to scatter even when the glass breaks according to a deeper crack, the critical stress intensity factor K_{IC} is more preferably 0.77 MPa·m^{1/2} or more, 0.79 MPa·m^{1/2} or more, 0.8 MPa·m^{1/2} or more, 0.82 MPa·m^{1/2} or more, 0.84 MPa·m^{1/2} or more, 0.86 MPa·m^{1/2} or more, 0.88 MPa·m^{1/2} or more, or 0.9 MPa·m^{1/2} or more.

A Young's modulus of the chemically strengthened glass according to the embodiment is preferably 70 GPa or more. In order not only to enhance the critical stress intensity factor K_{IC} to increase the strength of the glass but also to suppress bifurcation of cracks to reduce the frangibility, which will be described later, the Young's modulus of the glass is more preferably 72 GPa or more, 73 GPa or more, 74 GPa or more, 75 GPa or more, 76 GPa or more, 77 GPa or more, 78 GPa or more, 79 GPa or more, 80 GPa or more, 81 GPa or more, 82 GPa or more, 83 GPa or more, 84 GPa or more, 85 GPa or more, 86 GPa or more, 88 GPa or more, or 90 GPa or more.

(Composition of Glass)

The chemically strengthened glass according to the embodiment is an aluminosilicate glass. Preferably, the chemically strengthened glass according to the embodiment is an aluminosilicate glass including at least one metal selected from a group consisting of alkali metals and alkaline earth metals. More preferably, the chemically strengthened glass according to the embodiment further includes Al₂O₃ and Li₂O.

In the following, the glass composition of the chemically strengthened glass may be referred to as a base composition of a chemically strengthened glass. A chemically strengthened glass is prepared by forming a compressive stress layer on a surface of a glass for chemical strengthening by an ion exchange process.

A part, in which a tensile stress is applied, of a sufficiently thick chemically strengthened glass (in the following, referred also to as a “tensile stress part”) is not subjected to the ion exchange process. Thus, the tensile stress part of the chemically strengthened glass is regarded to have the same composition as that before the chemical strengthening. The composition of the tensile stress part of the chemically strengthened glass may be referred to as a base composition of the chemically strengthened glass.

Although a composition of glass may be simply obtained by performing a semi-quantitative analysis using X-ray fluorescence, by performing a wet analysis method such as an inductively coupled plasma (ICP) spectrometry, the composition of glass is obtained with high precision.

In the following, content of each component will be indicated by a mole percentage expressed in terms of oxide, unless otherwise specifically noted. In the following, a phrase “substantially not including” means not including except for inevitable impurities included in a raw material or the like, i.e. not intentionally including. Specifically, the phrase indicates that the content in the composition of glass is less than 0.01 mol %.

The composition of the glass for chemically strengthening according to the present invention (base composition of the chemically strengthened glass according to the present invention) preferably includes, for example, 50 to 80% of SiO₂, 1 to 30% of Al₂O₃, 0 to 5% of B₂O₃, 0 to 4% of P₂O₅, 3 to 20% of Li₂O, 0 to 8% of Na₂O, 0 to 10% of K₂O, 0 to 20% of MgO, 0 to 20% of CaO, 0 to 20% of SrO, 0 to 15% of BaO, 0 to 10% of ZnO, 0 to 1% of TiO₂, and 0 to 8% of ZrO₂.

The glass for chemically strengthening according to the present invention includes, for example, a glass including 63 to 80% of SiO₂, 7 to 30% of Al₂O₃, 0 to 5% of B₂O₃, 0 to 4% of P₂O₅, 5 to 15% of Li₂O, 1 to 8% of Na₂O, 0 to 2% of K₂O, 3 to 10% of MgO, 0 to 5% of CaO, 0 to 20% of SrO, 0 to 15% of BaO, 1 to 10% of ZnO, 0 to 1% of TiO₂, and 0 to 8% of ZrO₂, and not including Ta₂O₅, Gd₂O₃ and Sb₂O₃.

Silicon dioxide (SiO₂) is a main component of glass. Silicon dioxide enhances a chemical durability of the glass, and reduces the occurrence of a crack when an indentation is formed on the glass surface. The content of silicon dioxide is preferably 50% or more. The content of silicon dioxide is more preferably, stepwise in the following, 54% or more, 58% or more, 60% or more, 63% or more, 66% or more, and 68% or more. On the other hand, when the content of silicon dioxide exceeds 80%, meltability is significantly decreased. The content of silicon dioxide is preferably 80% or less, more preferably 78% of less, and further preferably 76% or less, especially preferably 74% or less, and most preferably 72% or less.

Aluminum oxide (Al₂O₃) is a component for reducing frangibility of a chemical strengthened glass. In the following, low frangibility of glass means a small number of fragments when glass breaks. A glass with low frangibility is considered to be safe, because fragments are less likely to scatter when the glass breaks. Moreover, aluminum oxide contributes to an enhancement of an ion exchange performance during a chemical strengthening, and to an increase of compressive stress of a glass surface after the chemical strengthening. Thus, the content of aluminum oxide is preferably 1% or more. The aluminum oxide contributes to an increase of a glass transition temperature (Tg) and to an enhancement of a Young's modulus. The content of aluminum oxide is more preferably, stepwise in the following, 3% or more, 5% or more, 7% or more, 8% or more, 9% or more, 11% or more, 12% or more, and 13% or more. When the content of aluminum oxide exceeds 30%, an acid resistance is decreased, and a devitrification temperature is increased. Moreover, in such a condition, a viscosity of the glass increases, and meltability is decreased. The content of aluminum oxide is preferably 30% or less, more preferably 25% or less, further preferably 20% or less, particularly preferably 18% or less, and most preferably 15% or less. When the content of aluminum oxide is increased, a temperature of the molten glass becomes higher, and productivity is decreased. Taking into account the productivity of glass, the content of aluminum oxide is preferably 11% or less, and is more preferably, stepwise in the following, 10% or less, 9% or less, 8% or less, and 7% or less.

Boron oxide (B₂O₃) is a component for enhancing chipping resistance of the glass for chemical strengthening or the chemically strengthened glass, and enhancing the meltability. Although boron oxide is not an essential component, when the glass includes boron oxide, the content of boron oxide is, for enhancing meltability, preferably 0.5% or more, more preferably 1% or more, and further preferably 2% or more. On the other hand, when the content of boron oxide exceeds 8%, a stria is likely to occur when the glass is melt, and a quality of the glass for chemical strengthening may be degraded. Thus, the content of boron oxide is preferably 8% or less, more preferably 5% or less, further preferably 3% or less, and particularly preferably 1% or less. When a high acid resistance is prioritized, boron oxide is preferably not included.

Phosphorus oxide (P₂O₅) is a component for enhancing the ion exchange performance and enhancing the chipping resistance of the glass for chemical strengthening or the chemically strengthened glass. Phosphorus oxide may not be included. When phosphorus oxide is included in glass, the content of phosphorus oxide is preferably 0.01% or more, more preferably 0.02% or more, further preferably 1% or more, and particularly preferably 2% or more. On the other hand, when the content of phosphorus oxide exceeds 9%, solubility of a raw material may be degraded and homogeneity of glass may become lower, and the acid resistance may be significantly decreased. The content of phosphorus oxide is preferably 9% or less, more preferably 6% or less, further preferably 3% or less, and particularly preferably 1% or less. When a high acid resistance is prioritized, phosphorus oxide is preferably not included.

Lithium oxide (Li₂O) is a component contributing to the exchange of lithium (Li) ions with sodium (Na) ions on the glass surface, to increase the compressive stress on the glass surface and reduce the frangibility of the chemically strengthened glass. The content of lithium oxide is preferably 3% or more, more preferably 4% or more, further preferably 5% or more, particularly preferably 6% or more, and most preferably 7% or more. On the other hand, when the content of lithium oxide exceeds 20%, the acid resistance of the glass is significantly decreased. The content of lithium oxide is preferably 20% or less, more preferably 18% or less, further preferably 16% or less, particularly preferably 15% or less, and most preferably 13% or less. When the main purpose of lithium oxide is enhancing the ion exchange performance from sodium (Na) ions to potassium (K) ions, the content of lithium oxide is preferably 1% or less.

Sodium oxide (Na₂O) is a component contributing to the ion exchange, to form a compressive stress layer on the glass surface, and enhancing the meltability of the glass. In order to enhance the meltability of the glass, sodium oxide may be included. When the sodium oxide is included, the content of sodium oxide is preferably 1% or more. The content of sodium oxide is more preferably 2% or more, further preferably 2.5% or more, and particularly preferably 3% or more. On the other hand, when the content of sodium oxide exceeds 20%, the acid resistance of the glass is significantly decreased. The content of sodium oxide is preferably 20% or less, more preferably 18% or less, further preferably 16% or less, particularly preferably 15% or less, and most preferably 14% or less.

When an ion exchange process is performed, e.g. exchanging lithium ions on the glass surface with sodium ions and exchanging sodium ions on the glass surface with potassium ions, simultaneously, by immersing the glass in a mixed molten salt of potassium nitrate and sodium nitrate, the content of sodium oxide is preferably 10% or less, more preferably 9% or less, further preferably 8% or less, 7% or less, 6% or less, 5% or less, and 3% or less. Moreover, the content of sodium oxide is preferably 2% or more, more preferably 3% or more, and further preferably 4% or more.

Potassium oxide (K₂O) may be included in the glass in order to enhance the ion exchange performance, or the like. When potassium oxide is included, the content of potassium oxide is preferably 0.01% or more, 0.02% or more, 0.03% or more, 0.1% or more, 1% or more, further preferably 2% or more, and especially preferably 3% or more. On the other hand, when the content of potassium oxide exceeds 10%, the compressive stress on the glass surface is decreased. Thus, the content of potassium oxide is preferably 10% or less, more preferably 8% or less, further preferably 6% or less, particularly preferably 4% or less, and most preferably 2% or less.

Magnesium oxide (MgO) is a component for increasing the compressive stress on the surface of the chemically strengthened glass, and reducing the frangibility of the glass. Thus, magnesium oxide is preferably included in the glass. When magnesium oxide is included in the glass, the content of magnesium oxide is preferably 1% or more, 2% or more, 2.5% or more, 3% or more, 4% or more, 5% or more, 6% or more, 7% or more, and 8% or more. On the other hand, when the content of magnesium oxide exceeds 20%, a glass for chemically strengthening is likely to be devitrified at melting. The content of magnesium oxide is preferably 20% or less, more preferably, stepwise in the following, 18% or less, 15% or less, 14% or less, 13% or less, 12% or less, 11% or less, and 10% or less. In order to reduce devitrification due to crystal precipitation in manufacturing the glass, the content of magnesium oxide is preferably reduced. For reducing devitrification, the content of magnesium oxide is preferably 9% or less, more preferably 8% or less, and further preferably 6.5% or less.

Calcium oxide (CaO) is a component for enhancing the meltability of the glass for chemical strengthening, and reducing the frangibility of the chemically strengthened glass. Calcium oxide may be included in the glass. When calcium oxide is included, the content of calcium oxide is preferably 0.01% or more, 0.02% or more, 0.03% or more, 0.04% or more, 0.1% or more, 0.5% or more, 1% or more, further preferably 2% or more, particularly preferably 3% or more, and most preferably 5% or more. On the other hand, when the content of calcium oxide exceeds 20%, the ion exchange performance is significantly reduced. Thus, the content of calcium oxide is preferably 20% or less, more preferably 14% or less, and further preferably, stepwise in the following, 10% or less, 8% or less, 6% or less, 3% or less and 1% or less.

Strontium oxide (SrO) is a component for enhancing the meltability of the glass for chemical strengthening, and reducing the frangibility of the chemically strengthened glass. The strontium oxide may be included in the glass. When strontium oxide is included in the glass, the content of strontium oxide is preferably 0.5% or more, more preferably 1% or more, further preferably 2% or more, particularly preferably 3% or more, and most preferably 5% or more. On the other hand, when the content of strontium oxide exceeds 20%, the ion exchange performance is significantly reduced. Thus, the content of strontium oxide is preferably 20% or less, more preferably 14% or less, and further preferably, stepwise in the following, 10% or less, 8% or less, 6% or less, 3% or less and 1% or less.

Barium oxide (BaO) is a component for enhancing the meltability of the glass for chemical strengthening. Barium oxide may be included in the glass. When barium oxide is included in the glass, the content of barium oxide is preferably 0.5% or more, more preferably 1% or more, further preferably 2% or more, particularly preferably 3% or more, and most preferably 5% or more. On the other hand, when the content of barium oxide exceeds 15%, the ion exchange performance is significantly reduced. Thus, the content of barium oxide is preferably 15% or less, and more preferably, stepwise in the following, 10% or less, 8% or less, 6% or less, 3% or less and 1% or less.

Zinc oxide (ZnO) is a component for enhancing the meltability of the glass. Zinc oxide may be included in the glass. When zinc oxide is included in the glass, the content of zinc oxide is preferably 0.25% or more, 0.3% or more, 0.5% or more, 0.6% or more, 0.7% or more, and 0.8% or more. On the other hand, when the content of zinc oxide exceeds 10%, weather resistance of the glass is significantly reduced. Thus, the content of zinc oxide is preferably 10% or less, more preferably 7% or less, further preferably 5% or less, particularly preferably 2% or less, and most preferably 1% or less.

Titanium oxide (TiO₂) is a component for reducing the frangibility of the chemically strengthened glass. Titanium oxide may be included in the glass. When titanium oxide is included in the glass, the content of titanium oxide is preferably 0.01% or more, 0.1% or more, 0.15% or more, and further preferably 0.2% or more. On the other hand, when the content of titanium oxide exceeds 5%, the glass is likely to be devitrified at melting, and a quality of the chemically strengthened glass may be degraded. Thus, the content of titanium oxide is preferably 1% or less, more preferably 0.5% or less, and further preferably 0.25% or less.

Zirconium oxide (ZrO₂) is a component contributing to the ion exchange process to increase the compressive stress on the glass surface, and to reduce the frangibility of the glass for chemical strengthening. Zirconium oxide may be included in the glass. When zirconium oxide is included in the glass, the content of zirconium oxide is preferably 0.01% or more, 0.05% or more, 0.2% or more, 0.5% or more, and 1% or more. On the other hand, when the content of zirconium oxide exceeds 8%, the glass is likely to be devitrified at melting, and the quality of the chemically strengthened glass may be degraded. Thus, the content of zirconium oxide is preferably 8% or less, more preferably 6% or less, further preferably 4% or less, particularly preferably 2% or less and most preferably 1.2% or less.

Yttrium oxide (Y₂O₃), lanthanum oxide (La₂O₃) and niobium oxide (Nb₂O₅) are components for reducing the frangibility of the chemically strengthened glass. These oxides may be included in the glass. When these oxides are included in the glass, each of the contents of these oxides is preferably 0.5% or more, more preferably 1% or more, further preferably 1.5% or more, particularly preferably 2% or more, and most preferably 2.5% or more. On the other hand, when each of the contents of yttrium oxide, lanthanum oxide, and niobium oxide exceeds 8%, the glass is likely to be devitrified at melting, and the quality of the chemically strengthened glass may be degraded. Thus, each of the contents of yttrium oxide, lanthanum oxide, and niobium oxide is preferably 8% or less, more preferably 6% or less, further preferably 5% of less, particularly preferably 4% or less, and most preferably 3% or less.

A small amount of tantalum oxide (Ta₂O₅) or gadolinium oxide (Gd₂O₃) may be included in the glass in order to reduce the frangibility of the chemically strengthened glass. Tantalum oxide and gadolinium oxide increase a refractive index and reflectance of glass. Thus, the contents of these oxides are preferably 1% or less, more preferably 0.5% or less. Further preferably, these oxides are not included in the glass.

In order to color the glass, within a range not to prevent the effect of the chemical strengthening from reaching the desired level, a coloration component may be added to the glass. The coloration component includes preferably, for example, cobalt oxide (Co₃O₄), manganese dioxide (MnO₂), diiron trioxide (Fe₂O₃), nickel oxide (NiO), copper oxide (CuO), dichromium trioxide (Cr₂O₃), vanadium oxide (V₂O₅), bismuth oxide (Bi₂O₃), selenium oxide (SeO), cerium oxide (CeO₂), erbium oxide (Er₂O₃), neodymium oxide (Nd₂O₃), and the like.

The content of the coloration components is preferably 7 mol % or less in total, based on oxides. When the content exceeds 7%, the glass is likely to be devitrified, and it is not desirable. The content is preferably 5% or less, more preferably 3% or less, and further preferably 1% or less. When a visible light transmittance of the glass is prioritized, the coloration components are preferably not included in the glass.

A fining agent at melting of glass such as sulfur trioxide (SO₃), chloride, fluoride, tin dioxide (SnO₂) may be added to the glass. Among the above-described fining agents, sulfur trioxide (SO₃) is preferably used. Concentration of sulfur trioxide remaining in the glass is preferably 0.01%, more preferably 0.02%, and further preferably 0.03% or more. Arsenic oxide (As₂O₃) or antimony oxide (Sb₂O₃) is preferably not included in the glass. When tin dioxide (SnO₂) is included in the glass, concentration of tin dioxide is preferably 0.3% or less, and more preferably 0.1% or less. When a color adjustment is performed by using changes in valence of iron (Fe) ions, tin dioxide is most preferably not included in the glass.

(Chemical Strengthening Process)

In the chemical strengthening process, a glass substrate is immersed in a melt of alkali metal salt, such as potassium nitrate, including alkali metal ions with large ion radii, such as potassium ions, so that a surface of the glass substrate is made to contact with the melt. Then, metal ions with small ion radii, such as sodium ions, included in the glass substrate are replaced with the metal ions with large ion radii.

The chemical strengthening process is performed by, for example, immersing a glass plate in molten salt of potassium nitrate at a temperature of 350° C. to 500° C., for a period of 5 minutes to 60 hours.

The molten salt for the above-described ion exchange process includes, for example, alkali nitrate salt, alkali sulfate salt and alkali chloride salt, such as potassium nitrate, potassium sulfate, potassium carbonate, and potassium chloride. The above-described molten salt may be used singly, or two or more types of molten salts may be used in combination. Moreover, in order to control the characteristic of the chemical strengthening, salt including sodium (sodium ions) or lithium (lithium ions) may be added to the molten salt.

A processing condition of the chemical strengthening processing for the chemically strengthened glass according to the embodiment is not particularly limited, and an optimum condition can be selected taking into account the characteristic of the glass, molten salt, and the like.

The chemically strengthened glass according to the embodiment is manufactured through the following steps (1) to (3). In the following, each of the steps (1) to (3) will be described in detail.

(1) First chemical strengthening process for forming a compressive stress layer on a glass surface by performing an ion exchange process for the glass

In step (1), a glass for chemical strengthening is caused to contact with molten salt including alkali metal ions (e.g. potassium ions) having greater ion radii than ion radii of alkali metal ions (e.g. sodium ions) included in the glass at a temperature lower than the glass transition temperature. The alkali metal ions in the glass are replaced with the alkali metal ions having greater ion radii in the molten salt. According to a difference in occupation areas of the alkali metal ions, a compressive stress occurs on the glass surface, and a compressive stress layer is formed.

The temperature and a processing time for the contact process between the glass and the molten salt including alkali metal ions are appropriately determined according to the compositions of the glass and the molten salt. Typically, a heat temperature of the molten salt is preferably 350° C. or higher, and more preferably 370° C. or higher. Moreover, typically the temperature is preferably 500° C. or lower, and more preferably 450° C. or lower. When the heat temperature of the molten salt is 350° C. or higher, progress of the chemical strengthening process is prevented from being hampered due to reduction of the ion exchange rate. Moreover, when the heat temperature is 500° C. or lower, the molten salt is prevented from being dissolved or deteriorating.

In order to give a sufficient compressive stress to the glass, the processing time for the contact process between the glass and the molten salt in step (1) is preferably 1 hour or more, and more preferably 2 hours or more, 3 hours or more, 4 hours or more, or 5 hours or more. Moreover, a long time process for ion exchange reduces the productivity and the compressive stress becomes reduced due to relaxation. Thus, the processing time is preferably 200 hours or less, and more preferably 150 hours or less, 100 hours or less, 90 hours or less, or 80 hours or less.

(2) Heating process for heating glass

In step (2), the glass with the compressive stress layer on the glass surface, obtained by step (1), is heated, and the alkali metal ions (e.g. potassium ions) having greater ion radii included in the compressive stress layer are moved from the glass surface toward the inside of the glass. Thus, the deepest part of the compressive stress layer is moved from the glass surface toward the inside of the glass. The above-described process may be omitted.

When the deepest part of the compressive stress layer is moved from the glass surface toward the glass inside, the compressive stress on the glass surface is decreased, but a compressive stress layer preferably having a thickness of 300 μm or more from the glass surface is formed.

The temperature for heating the glass is lower than the glass transition temperature by 50° C. or more, preferably by 70° C. or more, and more preferably by 100° C. or more. When the glass is heated at a temperature lower than the glass transition temperature by 50° C. or more, a stress relaxation can be prevented.

The time for heating the glass is preferably changed appropriately according to the temperature for heating the glass. Typically, the time preferably falls within a range of 30 minutes to 2000 minutes, and more preferably falls within a range of 30 minutes to 300 minutes.

(3) Second chemical strengthening process for changing the compressive stress layer on the glass surface by performing the ion exchange process for the glass

In step (3), the compressive stress layer on the surface of the glass obtained in step (2) is changed by the ion exchange process. According to the ion exchange process in step (3), the compressive stress layer on the surface of the glass and the compressive stress layer in the glass are changed. The ion exchange process in step (3) may be performed by the same method as the method used in step (1) for the ion exchange process. Alternatively, the method in step (3) may be different from the method in step (1). Furthermore, a molten salt in the ion exchange process in step (3) may be different from the molten salt in step (1).

The processing time and temperature for the contact process between the glass and the molten salt including alkali metal ions in step (3) is appropriately determined according to the compositions of the glass and of the molten salt. The heat temperature of the molten salt is preferably 350° C. or higher, and more preferably 370° C. or higher. Moreover, the temperature is preferably 500° C. or lower, and more preferably 450° C. or lower. When the heat temperature of the molten salt is 350° C. or higher, progress of the chemical strengthening process is prevented from being hampered due to the reduction of the ion exchange rate. Moreover, when the heat temperature is 500° C. or lower, the molten salt is prevented from being dissolved or deteriorating.

In order to give a sufficient compressive stress to the glass, the processing time for the contact process between the glass and the molten salt in step (3) is preferably 5 minutes of more, and more preferably, 6 minutes of more, 7 minutes or more, 8 minutes or more, 9 minutes or more, or 10 minutes or more. Moreover, a long time process for ion exchange reduces the productivity and the compressive stress becomes reduced due to relaxation. Thus, the processing time is preferably 5 hours or less, and more preferably 3 hours or less, 2 hours or less or 1 hour or less.

Steps (1) to (3) may be performed sequentially in an in-line manner for successive processes, such as a glass ribbon continuously conveyed in the glass plate manufacturing process, or may be performed discontinuously in an in-line manner. Moreover, in order to enhance the work efficiency, step (2) is preferably omitted. In order to further enhance the work efficiency, step (3) may be omitted. Thus, the chemical strengthening process is classified into four types, i.e. (i) performing steps (1), (2) and (3); (ii) performing steps (1) and (2); (iii) performing steps (1) and (3); and (iv) performing only step (1).

The molten salt used in the ion exchange process preferably includes at least potassium ions. Such a molten salt preferably includes, for example, a salt including 50 mass% or more of potassium nitrate. Moreover, a mixed molten salt including other components may be used. The other components include, for example, alkali sulfate, such as sodium sulfate or potassium sulfate; and alkali chloride, such as sodium chloride or potassium chloride.

(Manufacturing Method of Glass)

The manufacturing method of the chemically strengthened glass according to the embodiment is not particularly limited. The method of forming a molten glass is not particularly limited. For example, raw materials of glass are appropriately prepared, and are melted by heating at 1500° C. to 1700° C. The molten glass is subjected to a defoaming process, an agitation process and the like, to be homogenized. The homogenized glass is formed into a plate shape by using a known method, such as a float method, a down-draw method (fusion method), or a pressing method; or into a block shape by casting the molten glass. The formed glass is annealed, and cut into pieces with desired size; thereby a glass plate is manufactured. A polishing process is performed for the manufactured glass plate as necessary. A fluorine treatment for a glass surface may be added to the polishing process, or instead of the polishing process. In order to stably manufacture glass plates, the float method or the down-draw method is preferably employed. For manufacturing large-sized glass plates, in particular, the float method is preferable.

(Drop Test on Asphalt Surface)

A cover glass was mounted in a smartphone or in a casing simulating a smartphone, and the smartphone or the casing was dropped on a flat surface of asphalt. When the glass dropped from a low height (e.g. 10 cm) did not break, the drop height was increased and the glass was dropped again. When the glass broke, the drop height was assigned to the strength of the glass. An orientation of the test casing was determined so that the glass of the dropped casing came into contact with the asphalt surface. The glass used for the test had a rectangular shape with four corners and had dimensions of 120 mm×60 mm. A total weight of the simulation casing and the glass was set to be about 140 g.

The chemically strengthened glass according to the embodiment has a size of a display unit of an electronic device, such as a tablet type personal computer or a smartphone. The chemically strengthened glass may have a size of a window glass in a building or a house. The glass according to the embodiment has a rectangular shape. The present invention is not particularly limited to this, and the shape of the glass includes a circle, a polygon, and the like. The glass of the embodiment may have a hole.

The chemically strengthened glass according to the embodiment is preferably subjected prior to chemical strengthening to shape machining corresponding to the purpose of use, e.g. machining such as cutting, end face machining, or drilling machining.

The chemically strengthened glass according to the embodiment can be cut after the chemical strengthening process. The typical scribing and breaking process using a wheel chip cutter can be applied to the cutting process. Alternatively, a laser also can be applied to the cutting process. After the cutting process, a chamfering process may be performed for a cut edge in order to maintain the glass strength. A grinding process may be performed as the chamfering process. Alternatively, a fluorine treatment using hydrofluoric acid may be performed.

The purpose of the chemically strengthened glass according to the embodiment is not particularly limited. The chemically strengthened glass has a great mechanical strength, and is preferably applied to a part that may be subject to impact by being dropped, or may contact with other materials.

The chemically strengthened glass according to the embodiment is used for protecting an apparatus, a device or the like, applied specifically to a cover glass of a display unit of an apparatus, including a mobile phone (including a multi-functional information terminal, such as a smartphone), a PHS, a PDA, a tablet type terminal, a laptop type personal computer, a gaming machine, a portable music and movie playback machine, an electronic book device, an electronic terminal, a watch, a camera, a GPS device or the like; a cover glass of a monitor device for touch panel operations provided in the above-described apparatus; a cover glass of a cooking apparatus such as a microwave oven, an oven toaster, or the like; a top plate of an electromagnetic cooking device; a cover glass of an instrument, such as a meter or a gauge; or a glass plate of an image reading unit of a copying machine, a scanner, or the like.

Moreover, the chemically strengthened glass according to the embodiment is applied also to, for example, a window glass in a vehicle, a ship, an aircraft, or the like; a lighting apparatus in a house, or an industrial lighting apparatus; a cover glass of a signaling device, a guide light device, or an electric bulletin device; a showcase; or a bulletproof glass. Furthermore, the chemically strengthened glass according to the embodiment is applied to a cover glass protecting a photovoltaic cell, and a light condensing glass plate for enhancing a power generation efficiency of the photovoltaic cell.

Moreover, the chemically strengthened glass according to the embodiment is applied also to, for example, a glass for various types of mirror surfaces; a base plate of an information recording medium such as a hard disk; or a base plate of an information recording medium such as a compact disc (CD), a digital versatile disk (DVD), or a Blu-Ray (trademark registered) disk.

Moreover, the chemically strengthened glass according to the embodiment is applied also to, for example, an aquarium; a tableware, such as a cup or a dish; a cookware, such as a bottle or a chopping board; a cupboard; a shelf plate of a refrigerator; or a building material such as a wall, a roof, or a partition.

In addition to the above-described purpose of use, the chemically strengthened glass according to the embodiment, manufactured by performing the chemical strengthening process, is preferably applied to a glass plate of a display device installed in various types of image display apparatus, such as a liquid crystal display device, a plasma type display device, or an organic electro luminescence display device.

### EXAMPLES

In Examples which will be described in the following, the present invention will be specifically described. However, the present invention is not limited to Examples described in the present application. Examples 1, 2, 5 to 7 show practical examples. Examples 3 and 4 describe comparative examples.

In Examples 1 to 3, using the float method, a glass plate was manufactured. The glass included 64.3% of SiO₂, 10.5% of Al₂O₃, 16.0% of Na₂O, 0.8% of K.₂O, 8.3% of MgO, 0.2% of ZrO₂, and 0.04% of TiO₂, indicated by a mole percentage expressed in terms of oxide. The above-described compositions were obtained by X-ray fluorescence analysis. Silica sand, soda ash, dolomite, feldspar, and sodium sulfate were prepared for a glass raw material, and were melted by combustion of a natural gas. The molten glass was formed into a glass ribbon in a float bath.

In Example 4, using the fusion method, a glass plate was manufactured. The glass included 67.1% of SiO₂, 3.6% of B₂O₃, 13.1% of Al₂O₃, 13.7% of Na₂O, 0.1% of K₂O, and 2.3% of MgO, indicated by a mole percentage expressed in terms of oxide.

In Examples 5 and 6, glass raw materials were prepared so that the glass included 70% of SiO₂, 10% of Al₂O₃, 10% of Li₂O, 4% of Na₂O, 1% of K₂O, 4% of MgO, and 1% of ZrO₂, and weighed so as to obtain 1000 g of glass. In Example 7, glass raw materials were prepared so that the glass included 69% of SiO₂, 9% of Al₂O₃, 9.5% of Li₂O, 4.5% of Na₂O, 1% of K₂O, 6% of MgO, and 1% of ZrO₂, and weighed so as to obtain 1000 g of glass. Then, the raw materials were melted in a platinum crucible by an electric furnace at a temperature of 1500° C. to 1700° C. for about 3 hours, defoamed and homogenized. The molten glass obtained as above was poured into a mold, maintained for 1 hour at a temperature higher than the glass transition temperature by 50° C., and cooled to a room temperature at a rate of 0.5° C./minute, thereby a glass block was obtained. The glass block was cut into pieces, and surfaces of the piece of glass were ground. A mirror finish polishing process was performed on both surfaces of the ground pieces of glass, and a glass plate with a thickness of 0.8 mm was obtained.

For the glass plates according to Examples 1 to 3 and 5 to 7, from among the glass plates prepared as above, i.e. except for the glass plate according to Example 4, the drop test on asphalt surface was preformed. The glass plates according to Examples 1 and 5 to 7 were subjected to the above-described process of step (1), in which the chemical strengthening process was performed under the strengthening condition shown in TABLE 1 for the glass plates according to Examples 1 and 5 to 7, before the drop test on asphalt surface. The glass plates according to Examples 2 and 3 were subjected to the above-described process of step (1), in which the chemical strengthening process was performed under the strengthening condition shown in TABLE 1 for the glass plates according to Examples 2 and 3, and subsequently the above-described process of step (2), i.e. subjected to the heat treatment under the heat treatment conditions A and B shown in TABLE 1, in which the heat treatment under the heat treatment condition A was performed for the glass plates, and subsequently the heat treatment under the heat treatment condition B was performed for the glass plates, before the drop test on asphalt surface.

The cover glass subjected to the chemical strengthening process was installed in a casing simulating a smartphone, and was dropped on a flat surface of asphalt. When the glass dropped from a low height (e.g. 10 cm) did not break, the drop height was increased and the glass was dropped again. When the glass broke, the drop height was recorded. This procedure of increasing the drop height until the glass broke in the test was repeated 20 times. A drop height of glass breakage was defined to be an average value of the drop heights when the glass broke. An orientation of the test casing was determined so that the glass of the dropped casing came into contact with the asphalt surface. The glass used for the test had a rectangular shape with four corners and had dimensions of 120 mm×60 mm. A total weight of the simulation casing and the glass was set to be about 140 g.

Moreover, a critical stress intensity factor K_{IC} for each of the glass plates according to Examples 1 to 7 was obtained using a K_{I}-V curve obtained by a double cleavage drilled compression (DCDC) method.

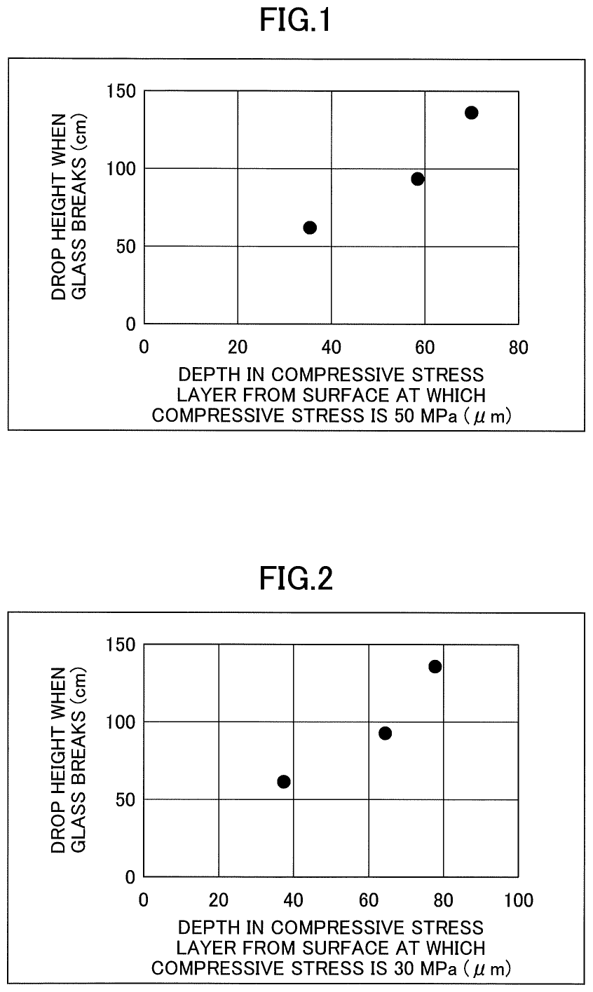

Results of calculation are shown in FIGS. 1 and 2, and TABLE 1. TABLE 1 also shows the strengthening conditions and the heat treatment conditions.

FIG. 1 shows a relation between a depth at which the compressive stress is 50 MPa from the glass surface and the drop height of glass breakage, for the chemically strengthened glass according to Examples 1 to 3. FIG. 2 shows a relation between a depth at which the compressive stress is 30 MPa from the glass surface and the drop height of glass breakage, for the chemically strengthened glass according to Examples 1 to 3.

It is found, from FIG. 1 and TABLE 1, that when the depth at which the compressive stress is 50 MPa from the glass surface is 36 μm, the glass in an electronic device dropped from the height of 62 cm on a flat surface of asphalt easily breaks. Heights from the ground of positions of clothes pockets of high school students or people older than high school students are usually greater than 60 cm. Thus, strength of such a glass is insufficient in practical use. However, it is found that when the depth at which the compressive stress is 50 MPa from the glass surface is 59 μm, the glass in an electronic device dropped from the height of 60 cm on the flat surface of asphalt is unlikely to break. Thus, when the depth at which the compressive stress is 50 MPa from the glass surface is 50 μm, the glass can be prevented from breaking in practical use by a typical user.

Moreover, it is found, from FIG. 2, that when the depth at which the compressive stress is 30 MPa from the glass surface is 40 μm, the glass in an electronic device dropped from the height of 60 cm on the flat surface of asphalt easily breaks. Thus, strength of such a glass is insufficient in practical use. However, it is found that when the depth at which the compressive stress is 30 MPa from the glass surface is 60 μm, the glass in the electronic device dropped from the height of 60 cm on the flat surface of asphalt is unlikely to break. Thus, when the depth at which the compressive stress is 30 MPa from the glass surface is 60 ·m, the glass can be prevented from breaking in practical use by a typical user.

A plate thickness of the glass plates according to Examples 1 to 3 was 2 mm. When the glass plate is dropped from a high height, a deep crack is considered to enter from the glass surface, and the compressive stress around a tip of the crack is considered to play an important role in determining a breakage of the glass plate. The above-described consideration would be irrespective of the plate thickness. Thus, the consideration can be applied to glass plates with plate thickness of 1 mm or less, 0.8 mm or less, or 0.5 mm or less.

TABLE 1

| | | Ex. 1 | Ex. 2 | Ex. 3 | Ex. 4 | Ex. 5 | Ex. 6 | Ex. 7 |
|---|---|---|---|---|---|---|---|---|
| Composition | SiO₂ | 64.3 | | | 67.1 | 70.0 | | 69.0 |
| (mol %) | Al₂O₃ | 10.5 | | | 13.1 | 10.0 | | 9.0 |
| | B₂O₃ | 0.0 | | | 3.6 | 0.0 | | 0.0 |
| | Li₂O | 0.0 | | | 0.0 | 10.0 | | 9.5 |
| | Na₂O | 16.0 | | | 13.7 | 4.0 | | 4.5 |
| | K₂O | 0.8 | | | 0.1 | 1.0 | | 1.0 |
| | MgO | 8.3 | | | 2.3 | 4.0 | | 6.0 |
| | ZrO₂ | 0.2 | | | 0.0 | 1.0 | | 1.0 |
| | TiO₂ | 0.04 | | | 0.0 | 0.0 | | 0.0 |
| K_{TC} (MPa · m^{1/2}) | | 0.81 | | | 0.74 | 0.82 | | 0.81 |
| Young's modulus (GPa) | | 73.0 | | | 69.3 | 83.5 | | 84.0 |
| Poisson ratio | | 0.22 | | | 0.22 | 0.21 | | 0.22 |
| Strengthening | KNO₃ concentration | 100 | 100 | 100 | — | 80 | 80 | 90 |
| condition at | (wt %) | | | | | | | |
| step (1) | NaNO₃ concentration | 0 | 0 | 0 | — | 20 | 20 | 10 |
| | (wt %) | | | | | | | |
| | Temperature (° C.) | 450 | 420 | 420 | — | 450 | 450 | 450 |
| | Time (min) | 210 | 1080 | 1440 | — | 120 | 90 | 90 |
| Strengthening | Temperature (° C.) | — | 420 | 420 | — | — | — | — |
| condition A | Time (min) | — | 480 | 660 | — | — | — | — |
| at step (2) | | | | | | | | |
| Strengthening | Temperature (° C.) | — | 450 | 450 | — | — | — | — |
| condition B | Time (min) | — | 15 | 15 | — | — | — | — |
| at step (3) | | | | | | | | |

| | | | | | | | |
|---|---|---|---|---|---|---|---|
| Surface compressive stress (MPa) | 800 | 210 | 230 | — | 630 | 647 | 661 |
| Depth at which compressive | 70 | 59 | 36 | — | 90 | 83 | 76 |
| stress is 50 MPa (μm) | | | | | | | |
| Depth at which compressive | 78 | 65 | 38 | — | 107 | 100 | 92 |
| stress is 30 MPa (μm) | | | | | | | |
| Drop height on asphalt surface | 136 | 93 | 62 | — | 138 | 132 | 125 |
| (cm) | | | | | | | |

TABLE 1 shows that the critical stress intensity factor K_{IC} of the glass according to Example 1 was 0.81 MPa·m^{1/2}, and the critical stress intensity factor K_{IC} of the glass according to Example 4 was 0.74 MPa·m^{1/2}. Although actual data of the drop test on asphalt surface are missing, the inventors' findings show that even if the depth at which the compressive stress is 50 MPa from the glass surface is 50 μm or more and the depth at which the compressive stress is 30 MPa from the glass surface is 60 μm or more, when the critical stress intensity factor K_{IC} is 0.75 MPa·m^{1/2} or less, the glass dropped on a surface of asphalt is considered to easily break. That is, a glass with a low critical stress intensity factor K_{IC} has a problem of frangibility.

As described above, the embodiments of the chemically strengthened glass have been described. The present invention is not limited to the embodiments. Various variations and modifications that a person skilled in the art will comprehend may be made for the configurations and details of the present invention without deviating from the scope of the present invention.

What is claimed is:

1. A chemically strengthened glass comprising a compressive stress layer,
wherein a compressive stress is 200 MPa or more at a surface of the chemically strengthened glass,
wherein a depth in the compressive stress layer at which the compressive stress is 50 MPa from the surface is 50 μm or more,
wherein a depth in the compressive stress layer at which the compressive stress is 30 MPa from the surface is 60 μm or more, and
wherein a critical stress intensity factor K_{IC} is 0.75 MPa·m^{1/2} or more.

2. The chemically strengthened glass according to claim 1,
wherein a Young's modulus is 70 GPa or more.

3. The chemically strengthened glass according to claim 1,
wherein the chemically strengthened glass is a aluminosilicate glass including aluminum oxide (Al₂O₃), boron oxide (B₂O₃), or both of aluminum oxide and boron oxide; and including at least one metal selected from a group consisting of alkali metals and an alkaline earth metals.

4. The chemically strengthened glass according to claim 3,
wherein the chemically strengthened glass includes aluminum oxide (Al₂O₃) and lithium oxide (Li₂O).

5. The chemically strengthened glass according to claim 1,
wherein a plate thickness is 2 mm or less.

6. The chemically strengthened glass according to claim 1,
wherein a plate thickness is 0.8 mm or less.
